(19) United States
(12) Patent Application Publication
(10) Pub. No.: US 2023/0004837 A1
(43) Pub. Date: Jan. 5, 2023

(54) INFERENCE DEVICE, INFERENCE METHOD AND INFERENCE PROGRAM

(71) Applicant: Tokyo Electron Limited, Tokyo (JP)

(72) Inventor: Takuro TSUTSUI, Hokkaido (JP)

(21) Appl. No.: 17/756,373

(22) PCT Filed: Nov. 16, 2020
(86) PCT No.: PCT/JP2020/042564

§ 371 Date: May 24, 2022

(30) Foreign Application Priority Data
Nov. 29, 2019 (JP) 2019-217439

(51) Int. Cl. G06N 5/04

(52) U.S. Cl. CPC G06N 5/04

(57) ABSTRACT

An inference device, an inference method, and an inference program that can realize high precision inference regardless of an application target are provided. An inference device includes: an acquisition section configured to acquire a time series data group measured in accordance with processing of a target object in a predetermined processing unit of a manufacturing process; and an inference section configured to tune respective output data that is output by processing the acquired time series data group using a plurality of network sections that have been machine-learned in advance and to output an inference result by combining the respective tuned output data; wherein the inference section is configured to tune the respective output data using a correction parameter corresponding to an error included in the inference result.

### TECHNICAL FIELD

The present disclosure relates to an inference device, an inference method, and an inference program.

### BACKGROUND ART

Conventionally, in the field of various manufacturing processes, inference techniques are known for inferring, from measurement data (a data set of multiple types of time series data, hereinafter referred to as a “time series data group”) measured during processing a target object, the state of the target object after processing and an event in a process during the processing.

As an example, in a semiconductor manufacturing process, a virtual measurement technique for inferring the state of a wafer after processing and an abnormality detection technique for inferring the presence or absence of an abnormality in the process during processing are known.

On the other hand, models used in these inference techniques (e.g., virtual measurement models, abnormality detection models) need to generate and optimize models on a process-by-process basis to realize more precise inference, which requires cost and time.

With respect to the above, if a model that achieves high-precision inference for a specific process can be applied to other processes of the same type, the cost and time required to optimize the model can be reduced.

### PRIOR ART DOCUMENT

### Patent Document

[Patent Document 1] Japanese Laid-open Patent Publication No. 2006-163517

### SUMMARY OF THE INVENTION

### Problem to be Solved by the Invention

The present disclosure provides an inference device, an inference method, and an inference program that can realize high precision inference regardless of an application target.

### Means for Solving the Problem

An inference device according to one aspect of the present disclosure has the following configuration, for example.

That is, the inference device includes:

an acquisition section configured to acquire a time series data group measured in accordance with processing of a target object in a predetermined processing unit of a manufacturing process; and

an inference section configured to tune respective output data that is output by processing the acquired time series data group using a plurality of network sections that have been machine-learned in advance and to output an inference result by combining the respective tuned output data;

wherein the inference section is configured to tune the respective output data using a correction parameter corresponding to an error included in the inference result.

### Effects of the Invention

According to the present disclosure, it is possible to provide an inference device, an inference method, and an inference program that can realize high precision inference regardless of an application target.

### BRIEF DESCRIPTION OF THE DRAWINGS

FIG. 1 is a diagram illustrating an example of an overall configuration of a system to which a virtual measurement device is applied;

FIG. 2 is a first diagram illustrating an example of predetermined processing units of a semiconductor manufacturing process;

FIG. 3 is a second diagram illustrating an example of predetermined processing units of a semiconductor manufacturing process;

FIG. 4 is a diagram illustrating an example of time series data groups to be acquired;

FIG. 5 is a diagram illustrating an example of a hardware configuration of virtual measurement devices;

FIG. 6 is a diagram illustrating an example of a functional configuration of a learning section of a virtual measurement device;

FIG. 7 is a first diagram illustrating a specific example of processing of a branch section;

FIG. 8 is a second diagram illustrating a specific example of the processing of the branch section;

FIG. 9 is a third diagram illustrating a specific example of the processing of the branch section;

FIG. 10 is a diagram illustrating a specific example of processing of a normalization section included in each network section;

FIG. 11 is a fourth diagram illustrating a specific example of the processing of the branch section;

FIG. 12 is a diagram illustrating an example of a functional configuration of an inference section of the virtual measurement device;

FIG. 13 is a flowchart illustrating a flow of virtual measurement processing performed by the virtual measurement device;

FIG. 14 is a first diagram illustrating an example of a functional configuration of the inference section with a fine-tuning function of the virtual measurement device;

FIG. 15 is a flowchart illustrating a flow of fine-tuning processing by the virtual measurement device; and

FIG. 16 is a second diagram illustrating an example of a functional configuration of an inference section with a fine-tuning function of the virtual measurement device.

### DESCRIPTION OF THE EMBODIMENTS

In the following, each embodiment will be described with reference to the accompanying drawings. In each of the following embodiments, a case will be described in which, for a specific semiconductor manufacturing process as a target, a time series data group measured in accordance with wafer processing is used to generate

a virtual measurement model that infers a state of a wafer after processing; or

an abnormality detection model that infers the presence or absence of an abnormality in the process. At this time, in each of the following embodiments, a model that realizes high-precision inference is generated by performing multifaceted analysis by processing a time series data group using a plurality of network sections.

In each of the following embodiments, by adding a fine-tuning function to the generated model, when the model is applied to other semiconductor manufacturing processes of the same type, errors (errors included in the inference result) caused by individual differences between processes are reduced by using the fine-tuning function.

Thereby, according to each of the following embodiments, it is possible to provide an inference device, an inference method, and an inference program that can realize high precision inference regardless of an application target. As a result, cost and time can be reduced compared to a case where a new model is generated for another semiconductor manufacturing process for optimization.

In the first embodiment of each of the embodiments, a case will be described in which a virtual measurement model is generated as a model based on a time series data group, and a correction matrix is used as a fine-tuning function. In the second embodiment, a case will be described in which a neural network is used instead of the correction matrix as a fine-tuning function will be described. Further, in the third embodiment, a case will be described in which, as a model based on a time series data group, an abnormality detection model is generated instead of the virtual measurement model.

In the following embodiments and the accompanying drawings, elements having substantially the same functional configurations are referred to by the same numerals, and a duplicate description thereof will be omitted.

### First Embodiment

<Application Example of Inference Device>

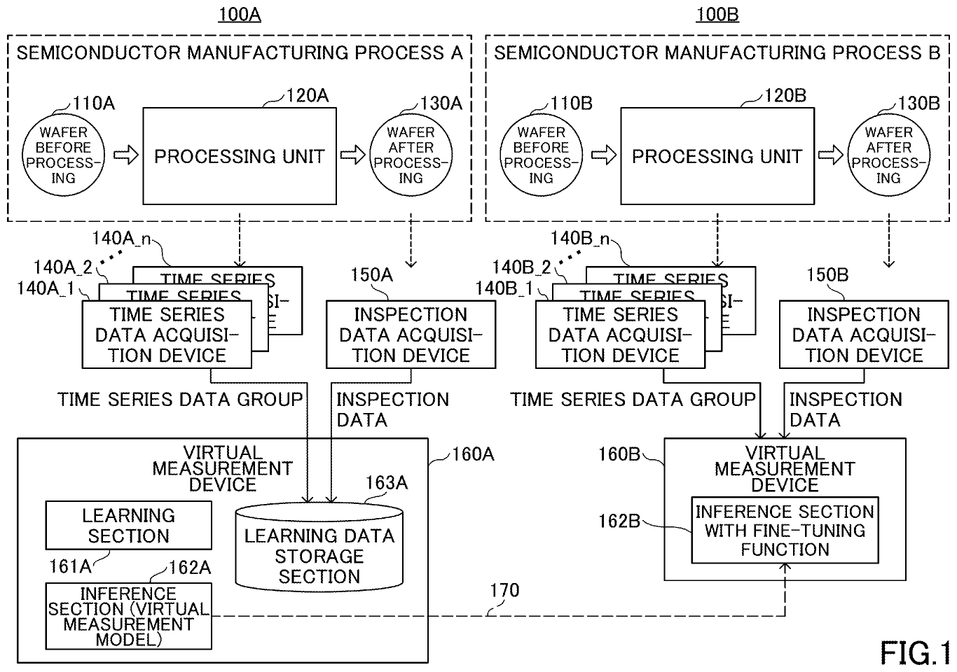

First, an application example of a virtual measurement device (inference device) with a fine-tuning function added to a virtual measurement model will be described. FIG. 1 is a diagram illustrating an example of an overall configuration of a system to which a virtual measurement device is applied.

As illustrated in FIG. 1, a system 100A includes a semiconductor manufacturing process A, time series data acquisition devices 140A_1 to 140A_n, an inspection data acquisition device 150A, and a virtual measurement device 160A. In the system 100A, for the semiconductor manufacturing process A that is a particular process, a virtual measurement model is generated to realize high-precision inference.

A system 100B includes a semiconductor manufacturing process B, time series data acquisition devices 140B_1 to 140B_n, an inspection data acquisition device 150B, and a virtual measurement device 160B. In the system 100B, the semiconductor manufacturing process B is another process similar to the semiconductor manufacturing process A, and in the present embodiment, the semiconductor manufacturing process B is a target to which a virtual measurement device (inference device) with a fine-tuning function added to the virtual measurement model generated in the system 100A is applied.

In the system 100A, the semiconductor manufacturing process A processes a target object (a wafer 110A before processing) in a predetermined processing unit 120A to generate a result (a wafer 130A after processing). It should be noted that that the processing unit 120A is an abstract concept and will be described in detail later. The wafer 110A before processing refers to a wafer (substrate) before being processed in the processing unit 120A, and the wafer 130A after processing refers to a wafer (substrate) after being processed in the processing unit 120A.

Further, in the system 100A, the time series data acquisition devices 140A_1 to 140A_n respectively measure the time series data in accordance with the processing of the wafer 110A before processing. The time series data acquisition devices 140A_1 to 140A_n measure kinds of measurement items different from each other. It should be noted that the number of measurement items measured by each of the time series data acquisition devices 140A_1 to 140A_n may be one or more. The time series data measured in accordance with the processing of the wafer 110A before processing includes not only a time series data measured during the processing of the wafer 110A before processing but also a time series data measured during pre-processing and post-processing that are performed before and after the processing of the wafer 110A before processing. These processing may include pre-processing and post-processing performed without a wafer (substrate).

A time series data group measured by the time series data acquisition devices 140A_1 to 140A_n is stored as learning data (input data) in a learning data storage section 163A of the virtual measurement device 160A.

In the system 100A, the inspection data acquisition device 150A inspects predetermined inspection items (e.g., an ER (Etch Rate)) of the wafer 130A after processing processed in the processing unit 120A to acquire inspection data. The inspection data acquired by the inspection data acquisition device 150A is stored in the learning data storage section 163A of the virtual measurement device 160A as learning data (labeled data).

In addition, in the system 100A, a virtual measurement program including a learning program and an inference program is installed in the virtual measurement device 160A. When the virtual measurement program is executed, the virtual measurement device 160A functions as a learning section 161A and an inference section 162A.

The learning section 161A performs machine learning by using the time series data group measured by the time series data acquisition devices 140A_1 to 140A_n and the inspection data acquired by the inspection data acquisition device 150A.

Specifically, a plurality of network sections included in the learning section 161A are used to process the time series data group, and machine learning is performed for the plurality of network sections so that the combined result of respective output data output from the plurality of network sections approaches the inspection data.

The inference section 162A acquires the time series data group measured in accordance with the processing of a new target object (wafer before processing) and inputs it to the plurality of network sections for which machine learning has been performed. Accordingly, the inference section 162A infers, based on the time series data acquired in accordance with the processing of the new wafer before processing, the inspection data of the wafer after processing and outputs the inference result (virtual measurement data).

As described above, by processing the time series data group measured in accordance with the processing of the target object using the plurality of network sections, the virtual measurement device 160A enables to analyze the time series data group from various aspects. As a result, a virtual measurement model (inference section 162A) that realizes high-precision inference can be generated compared to a case where the time series data group is processed using one network section.

On the other hand, in the system 100B, the semiconductor manufacturing process B is the same type of process as the semiconductor manufacturing process A of the system 100A. Further, in the system 100B, the time series data acquisition devices 140B_1 to 140B_n and the inspection data acquisition device 150B correspond to the time series data acquisition devices 140A_1 to 140A_n and the inspection data acquisition device 150A, respectively.

Further, in the system 100B, the virtual measurement device 160B (inference device) corresponds to the virtual measurement device 160A of the system 100A. However, in the case of the virtual measurement device 160B of the system 100B, the learning section 161A is not included. Also, instead of the inference section 162A, an inference section 162B with a fine-tuning function is included (a virtual measurement program that does not include a learning program but includes an inference program similar to the inference program installed in the virtual measurement device 160A is installed).

In a case of the virtual measurement device 160B of the system 100B, rather than generating a new virtual measurement model and performing machine learning by using the time series data group for optimization, the virtual measurement model (inference section 162A) generated in the virtual measurement device 160A of the system 100A is applied.

Here, the semiconductor manufacturing process A and the semiconductor manufacturing process B are the same type of process as described above, but have individual differences. Therefore, even if the virtual measurement model (the inference section 162A) generated in the virtual measurement device 160A is applied as it is, the inference result (virtual measurement data) includes an error.

Thus, in a case of the virtual measurement device 160B (the inference device), an inference section having a fine-tuning function added to the virtual measurement model (the inference section 162A) generated in the virtual measurement device 160A is generated. In FIG. 1, the inference section 162B with a fine-tuning function included in the virtual measurement device 160B is an example of the inference section having a fine-tuning function added to the virtual measurement model (the inference section 162A) generated in the virtual measurement device 160A.

To the inference section 162B with a fine-tuning function, while the virtual measurement model (the inference section 162A) generated in the virtual measurement device 160A is applied (see the dashed line 170), a fine-tuning function is added to reduce an error caused by an individual difference (error included in the inference result).

Specifically, the inference section 162B with a fine-tuning function updates correction parameters (parameters included in a correction matrix used when tuning respective output data, details are described below) so as to reduce an error between

an inference result (virtual measurement data) that is output by processing a time series data group using a plurality of network sections included in the generated virtual measurement model and combining respective output data output from the plurality of network sections after tuning; and

inspection data acquired by the inspection data acquisition device 150B.

As a result, the virtual measurement device 160B can realize a model generated in the virtual measurement device 160A and to which a virtual measurement model (inference section 162A) is applied to realize high-precision inference, which is a model capable of high-precision inference even for the semiconductor manufacturing process B that is an application target.

<Predetermined Processing Unit for Semiconductor Manufacturing Processes>

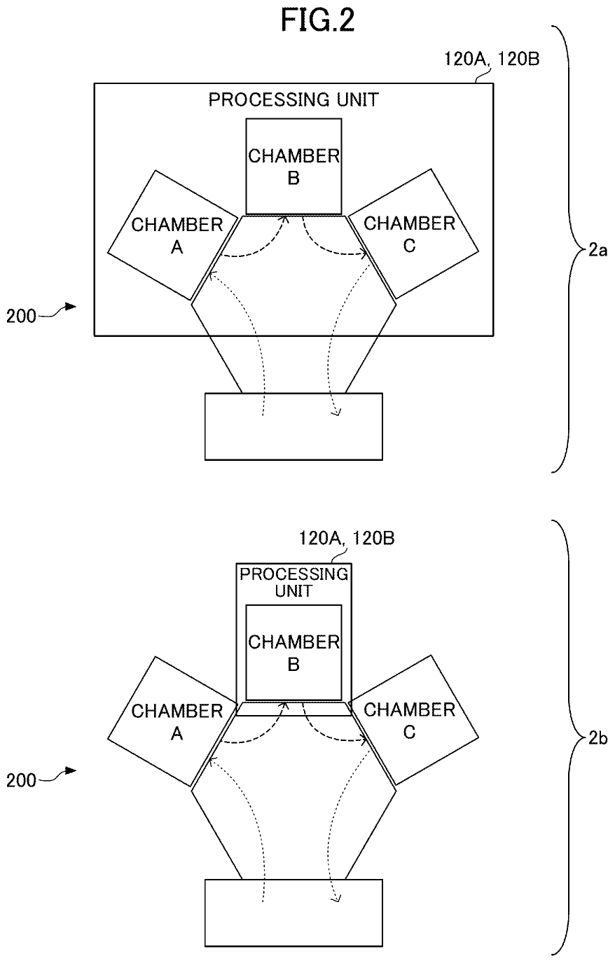

Next, the predetermined processing units 120A and 120B of the semiconductor manufacturing process A and B will be described. FIG. 2 is a first diagram illustrating an example of predetermined processing units of a semiconductor manufacturing process. As illustrated in FIG. 2, a semiconductor manufacturing device 200, which is an example of a substrate processing device, includes a plurality of chambers (one example of a plurality of processing spaces, in the example of FIG. 2, chamber A to chamber C), in which a wafer is processed in each chamber.

Here, 2a of FIG. 2 illustrates a case where a plurality of chambers are defined as processing units 120A and 120B. In this case, the wafers 110A and 110B before processing refer to wafers before being processed in the chamber A, and the wafers 130A and 130B after processing refer to wafers after being processed in the chamber C.

The time series data group measured in accordance with the processing of the wafers 110A and 110B before processing in the processing units 120A and 120B in 2a of FIG. 2 includes:

a time series data group measured in accordance with processing in the chamber A (first processing space);

a time series data group measured in accordance with processing in the chamber B (second processing space); and

a time series data group measured in accordance with processing in in the chamber C (third processing space).

On the other hand, 2b of FIG. 2 illustrates a case where one chamber (“chamber B” in the example of 2b of FIG. 2) is defined as the processing units 120A and 120B. In this case, the wafers 110A and 110B before processing refer to wafers before being processed in the chamber B (wafers after being processed in the chamber A). Also, the wafers 130A and 130B after processing refer to wafers after being processed in the chamber B (wafers before being processed in the chamber C).

In the processing units 120A and 120B of 2b of FIG. 2, the time series data group measured in accordance with the processing of the wafers 110A and 110B before processing includes the time series data group measured in accordance with the processing of the wafers 110A and 110B before processing in the chamber B.

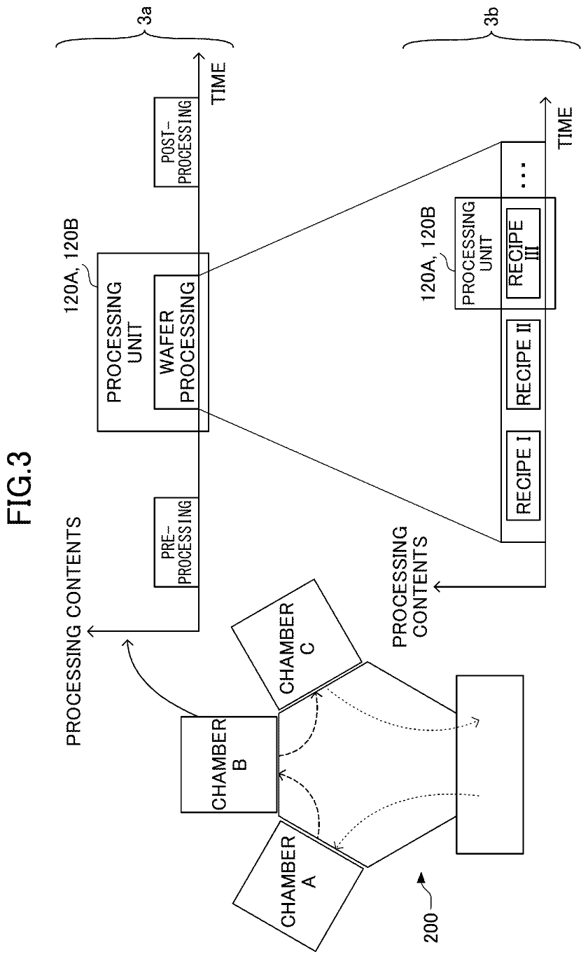

FIG. 3 is a second diagram illustrating an example of predetermined processing units of a semiconductor manufacturing process. Similar to FIG. 2, the semiconductor manufacturing device 200 includes a plurality of chambers, and a wafer is processed in each chamber.

Here, 3a of FIG. 3 illustrates a case where processing (referred to as “wafer processing”) excluding pre-processing and post-processing among the processing contents in the chamber B is defined as the processing units 120A and 120B. In this case, the wafers 110A and 110B before processing refer to wafers before wafer processing is performed (wafers after pre-processing is performed) and the wafers 130A and 130B after processing refer to wafers after wafer processing is performed (wafers before post-processing is performed).

Also, in the processing units 120A and 120B of 3a of FIG. 3, the time series data group measured in accordance with the processing of the wafers 110A and 110B before processing includes the time series data group measured in accordance with the wafer processing of the wafers 110A and 110B before processing in the chamber B.

In the example of 3a of FIG. 3, in a case in which pre-processing, wafer processing (the present processing), and post-processing are performed in the same chamber (in the chamber B), the wafer processing is described as the wafer processing units 120A and 120B. However, in a case in which each processing is performed in a different chamber (e.g., when pre-processing is performed in the chamber A, wafer processing is performed in the chamber B, and post-processing is performed in the chamber C), each processing for the corresponding chamber may be the processing units 120A and 120B.

On the other hand, 3b of FIG. 3 illustrates a case where the processing of one recipe (in the example of 3b of FIG. 3, “Recipe III”) included in the wafer processing among the processing contents in the chamber B is defined as the processing units 120A and 120B. In this case, the wafers 110A and 110B before processing refer to wafers before the processing of recipe III is performed (wafers after the processing of recipe II is performed). Also, the wafers 130A and 130B after processing refer to wafers after the processing of recipe III is performed (wafers before the processing of recipe IV (not illustrated) is performed).

Also, in the processing units 120A and 120B of 3a of FIG. 3, the time series data group measured in accordance with the processing of the wafers 110A and 110B before processing includes the time series data group measured in accordance with the wafer processing with the recipe III in the chamber B.

<Example of Time series Data Group>

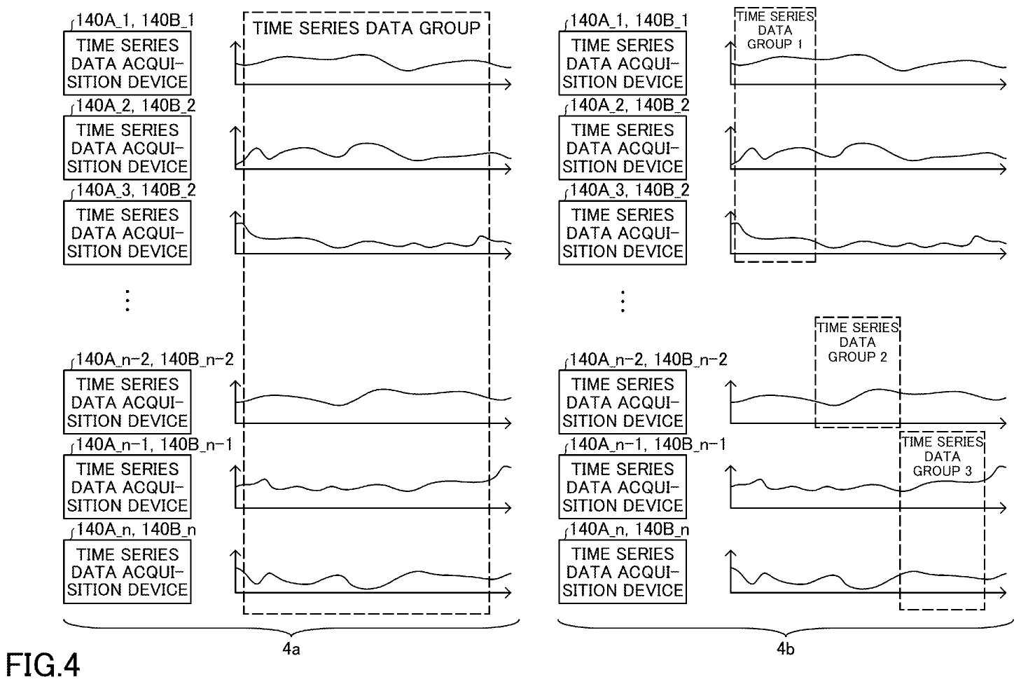

Next, a specific example of the time series data groups acquired by the time series data acquisition devices 140A_1 to 140A_n and 140B_1 to 140B_n will be described. FIG. 4 is a diagram illustrating an example of the time series data groups to be acquired. Incidentally, in the example of FIG. 4, for the simplicity of the explanation, the time series data acquisition devices 140A_1 to 140A_n and 140B_1 to 140B_n respectively measure one-dimensional data. However, one time series data acquisition device may measure two-dimensional data (a data set of multiple types of one-dimensional data).

Of these, 4a of FIG. 4 represents a time series data group of a case in which the processing units 120A and 120B are defined by one of 2b of FIG. 2, 3a of FIGS. 3, and 3b of FIG. 3. In this case, the time series data acquisition devices 140A_1 to 140A_n and 140B_1 to 140B_n acquire the time series data measured in accordance with the processing in the chamber B, respectively. The time series data acquisition devices 140A_1 to 140A_n acquire the time series data measured in the same time zone as a time series data group. Similarly, the time series data acquisition devices 140B_1 to 140B_n acquire the time series data measured in the same time zone as a time series data group.

On the other hand, 4b of FIG. 4 represents a time series data group of a case in which the processing units 120A and 120B are defined by 2a of FIG. 2. In this case, the time series data acquisition devices 140A_1 to 140A_3 and 140B_1 to 140B_3, for example, acquire the time series data group 1 measured in accordance with wafer processing in the chamber A. Also, the time series data acquisition devices 140A_n−2 and 140B_n−2 acquire, for example, the time series data group 2 measured in accordance with the wafer processing in the chamber B. Also, the time series data acquisition devices 140A_n−1 to 140A_n and 140B_n−1 to 140B_n, for example, acquire the time series data group 3 measured in accordance with the wafer processing in the chamber C.

In 4a of FIG. 4, a case is described in which the time series data acquisition devices 140A_1 to 140A_n and 140B_1 to 140B_n acquire time series data within the same time range measured in accordance with the processing of a wafer before processing in the chamber B as a time series data group. However, the time series data acquisition deices 140A_1 to 140A_n and 140B_1 to 140B_n may acquire, as a time series data group, time series data of different time ranges measured in accordance with the processing of a wafer before processing in the chamber B.

Specifically, the time series data acquisition devices 140A_1 to 140A_n and 140E_1 to 140E_n may acquire, as the time series data group 1, a plurality of sets of time series data measured during executing the pre-processing. The time series data acquisition devices 140A_1 to 140A_n and 140E_1 to 140E_n may acquire, as the time series data group 2, a plurality of sets of time series data measured during executing the wafer processing. Further, the time series data acquisition devices 140A_1 to 140A_n and 140E_1 to 140E_n may acquire, as the time series data group 3, a plurality of sets of time series data measured during executing the post-processing.

Similarly, the time series data acquisition devices 140A_1 to 140A_n and 140B_1 to 140E_n may acquire a plurality of sets of time series data measured during executing the recipe I as the time series data group 1. The time series data acquisition devices 140A_1 to 140A_n and 140B_1 to 140B_n may acquire a plurality of sets of time series data measured during executing the recipe II as the time series data group 2. Further, the time series data acquisition devices 140A_1 to 140A_n and 140B_1 to 140B_n may acquire a plurality of sets of time series data measured during executing the recipe III as the time series data group 3.

<Hardware Configuration of Virtual Measurement Device>

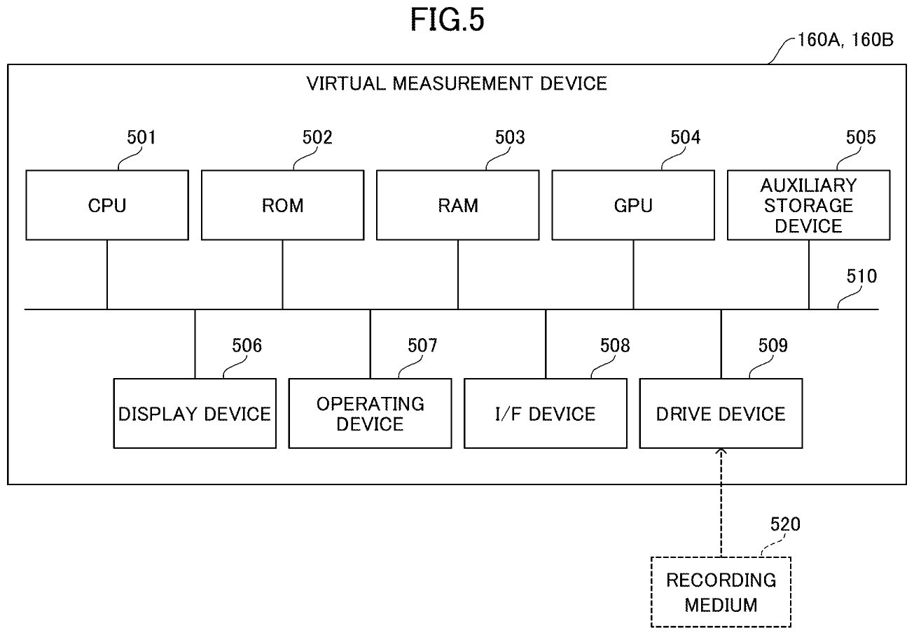

Next, a hardware configuration of the virtual measurement devices 160A and 160B will be described. FIG. is a diagram illustrating an example of a hardware configuration of the virtual measurement devices. As illustrated in FIG. 5, the virtual measurement devices 160A and 160B each includes a CPU (central processing unit) 501, a ROM (read only memory) 502, and a RAM (random access memory) 503. The virtual measurement device 160 also includes a GPU (Graphics Processing Unit) 504. The processors (processing circuit, processing circuitry) such as the CPU 501 and the GPU 504 and the memories such as the ROM 502 and the RAM 503 form a computer.

The virtual measurement device 160 further includes an auxiliary storage device 505, a display device 506, an operating device 507, an I/F (interface) device 508, and a drive device 509. The hardware parts of the virtual measurement device 160 are connected to one another through a bus 510.

The CPU 501 is an arithmetic device that executes various types of programs (e.g., a virtual measurement program) installed in the auxiliary storage device 505.

The ROM 502 is a nonvolatile memory and functions as a main memory device. The ROM 502 stores various types of programs, data, and the like necessary for the CPU 501 to execute the various types of programs installed in the auxiliary storage device 505. Specifically, the ROM 502 stores boot programs and the like such as BIOS (basic input/output system) and EFI (extensible firmware interface).

The RAM 503 is a volatile memory such as a DRAM (dynamic random access memory) or an SRAM (static random access memory) and functions as a main memory device. The RAM 503 provides a work area to which the various types of program installed in the auxiliary storage device 505 are loaded when executed by the CPU 501.

The GPU 504 is an arithmetic device for image processing, and when a virtual measurement program is executed by the CPU 501, the GPU 504 performs high-speed calculation by parallel processing on various image data (in the present embodiment, a time series data group). The GPU 504 is equipped with an internal memory (CPU memory), and temporarily holds information necessary for performing parallel processing on various image data.

The auxiliary storage device 505 stores various types of programs, and various types of data used when the various types of program are executed by the CPU 501.

The display device 506 is a display device that displays an internal state of the virtual measurement devices 160A and 160B. The operating device 507 is an input device that is used by an administrator of the virtual measurement devices 160A and 160B to input various types of instructions to the virtual measurement devices 160A and 160B. The I/F device 508 is a connection device for connecting to a non-illustrated network for performing communication.

The drive device 509 is a device for setting a recording medium 520. Here, the recording medium 520 includes a medium for optically, electrically, or magnetically recording information, such as a CD-ROM, a flexible disk, a magneto-optical disk, or the like. The recording medium 520 may also include a semiconductor memory or the like that electrically records information, such as a ROM, a flash memory, or the like.

The various types of programs to be installed in the auxiliary storage device 505 are installed by the drive device 509 reading the various types of programs recorded in the recording medium 520 upon the recording medium 520 being set in the drive device 509, for example. Alternatively, the various types of program to be installed in the auxiliary storage device 505 may be installed upon being downloaded from a network.

<Functional Configuration of Learning Section>

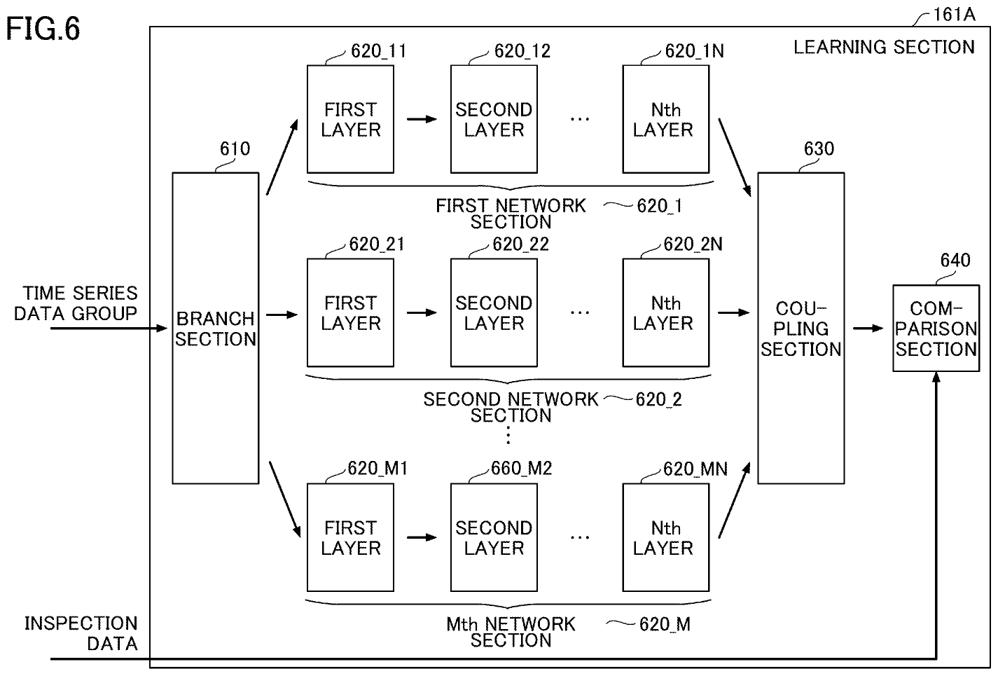

Next, a functional configuration of the learning section 161A of the virtual measurement device 160A in the system 100A will be described. FIG. 6 is a diagram illustrating an example of the functional configuration of the learning section of the virtual measurement device. The learning section 161A includes a branch section 610, a first network section 620_1 to an Mth network section 620_M, a coupling section 630, and a comparison section 640.

The branch section 610 reads out the time series data group from the learning data storage section 163A. The branch section 610 processes the read-out time series data group so that the time series data group is processed using a plurality of network sections from the first network section 620_1 to the Mth network section 620_M.

The first network section 620_1 to the Mth network section 620_M are configured based on a convolution neural network (CNN) and have a plurality of layers.

Specifically, the first network section 620_1 includes a first layer 620_1 to an Nth layer 620_1N. Similarly, the second network section 620_2 includes a first layer 620_21 to an Nth layer 620_2N. Hereinafter, a similar configuration is included, and the Mth network section 620_M includes a first layer 620_M1 to an Nth layer 620_MN.

In each layer of the first layer 620_1 to the Nth layer 620_1N of the first network section 620_1, various processes such as a normalization process, a convolution process, an activation process, and a pooling process are performed. Further, similar various processes are performed in each layer of the second network section 620_2 to the Mth network section 620_M.

The coupling section 630 combines respective output data from the output data output from the Nth layer 620_1N of the first network section 620_1 to the output data output from the Nth layer 620_MN of the Mth network section 620_M and outputs the combined result to the comparison section 640.

The comparison section 640 compares the combined result output from the coupling section 630 with the inspection data (labeled data) read from the learning data storage section 163A and calculates the error. In the learning section 161A, mechanical learning is performed for the first network section 620_1 to the Mth network section 620_M and the coupling section 630 so that the error calculated by the comparison section 640 satisfies a predetermined condition.

Thus, the model parameters of the respective layers of the first network section 620_1 to the Mth network section 620_M and the model parameters of the coupling section 630 are optimized.

<Details of Processing of Each Section of the Learning Section>

Next, the details of processing of each section (here, in particular, the branch section 610) of the learning section 161A of the virtual measurement device 160A in the system 100A will be described with reference to a specific example.

(1) Detail 1 of Processing of Branch Section

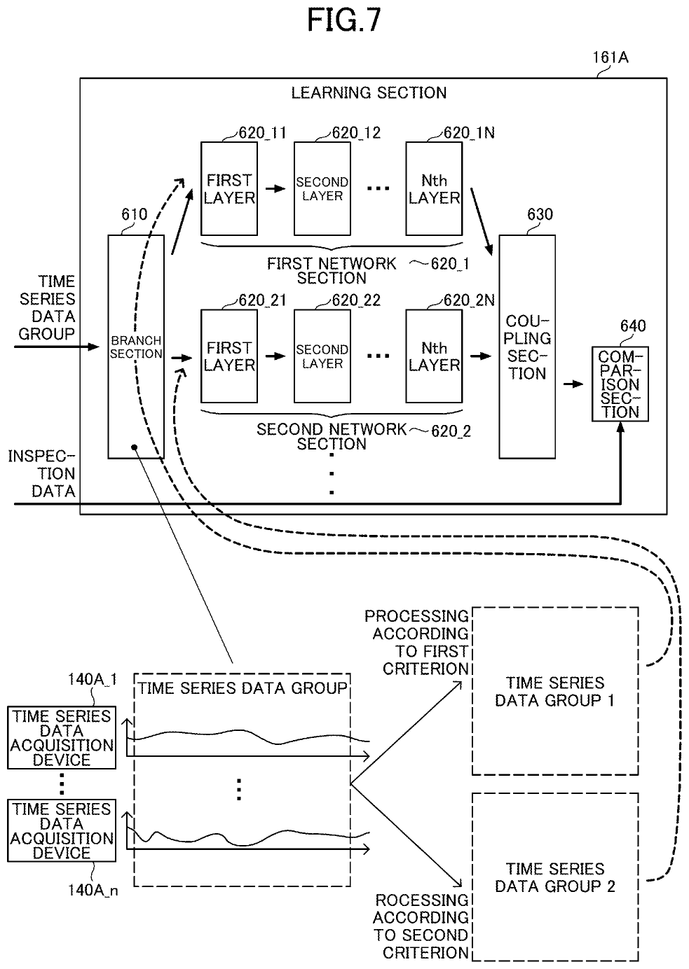

FIG. 7 is a first diagram illustrating a specific example of processing of the branch section. In the case of FIG. 7, the branch section 610 generates the time series data group 1 (the first time series data group) by processing the time series data group measured by the time series data acquisition devices 140A_1 to 140A_n according to a first criterion and inputs it to the first network section 620_1.

Also, the branch section 610 generates the time series data group 2 (the second time series data group) by processing the time series data group measured by the time series data acquisition devices 140A_1 to 140A_n according to a second criterion and inputs it to the second network section 620_2.

As described above, by processing the time series data groups according to different criteria to be processed with divided respective different network sections to perform machine learning, the time series data groups can be analyzed in a multifaceted manner. As a result, it is possible to generate a virtual measurement model (inference section 162A) that realizes high-precision inference compared to a case in which a time series data group is input to one network section and machine learning is performed.

In the example of FIG. 7, a case is described in which two kinds of time series data groups are generated by processing a time series data group according to two kinds of criteria. However, by processing a time series data group according to three kinds or more of criteria, three kinds or more of time series data groups may be generated.

(2) Detail 2 of Processing of Branch Section

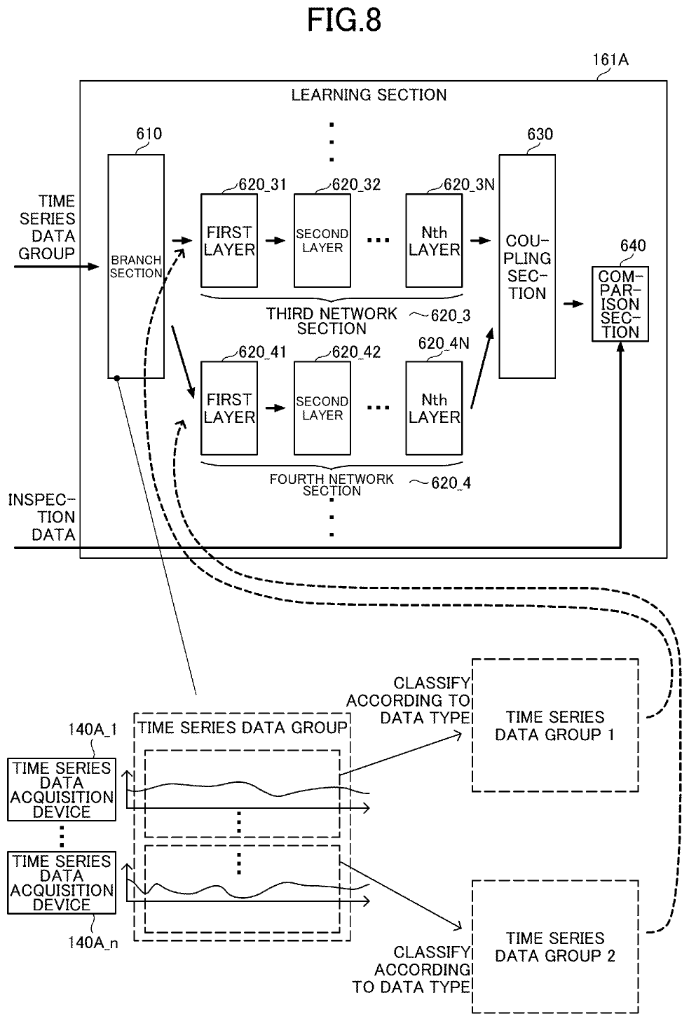

Next, another processing of the branch section 610 will be described in detail. FIG. 8 is a second diagram illustrating a specific example of the processing of the branch section. In a case of FIG. 8, the branch section 610 divides a time series data group measured by the time series data acquisition devices 140A_1 to 140A_n into groups according to a data type. Therefore, the branch section 610 generates the time series data group 1 (the first time series data group) and the time series data group 2 (the second time series data group). The branch section 610 inputs the generated time series data group 1 to the third network section 620_3 and inputs the generated time series data group 2 to the fourth network section 620_4.

As described above, by dividing the time series data group into a plurality of groups according to a data type and by processing using different network sections to perform machine learning, the time series data group can be analyzed in a multifaceted manner. As a result, it is possible to generate a virtual measurement model (inference section 162A) that realizes high-precision inference compared to a case in which a time series data group is input to one network section and machine learning is performed.

In the example of FIG. 8, a time series data group is divided into groups according to a difference in data type based on a difference in the time series data acquisition device 140A_1 to 140A_n. However, a time series data group may be divided into groups according to a time range in which data is acquired. For example, in a case in which the time series data group is a time series data group measured in accordance with processing by a plurality of recipes, the time series data group may be divided into groups according to the time range for each recipe.

(3) Detail 3 of Processing of Branch Section

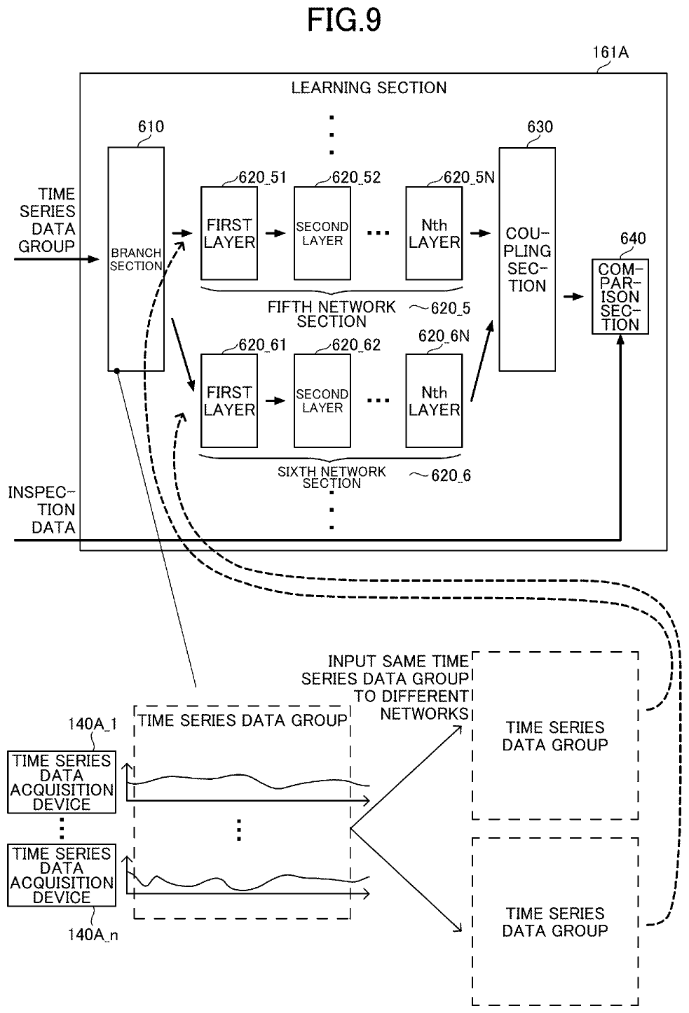

Next, another processing of the branch section 610 will be described in detail. FIG. 9 is a third diagram illustrating a specific example of the processing of the branch section. In a case of FIG. 9, the branch section 610 inputs the time series data group acquired by the time series data acquisition devices 140A_1 to 140A_n to both the fifth network section 620_5 and the sixth network section 620_6. Then, different processings (normalization processes) are performed for the same time series data group by the fifth network section 620_5 and the sixth network section 620_6.

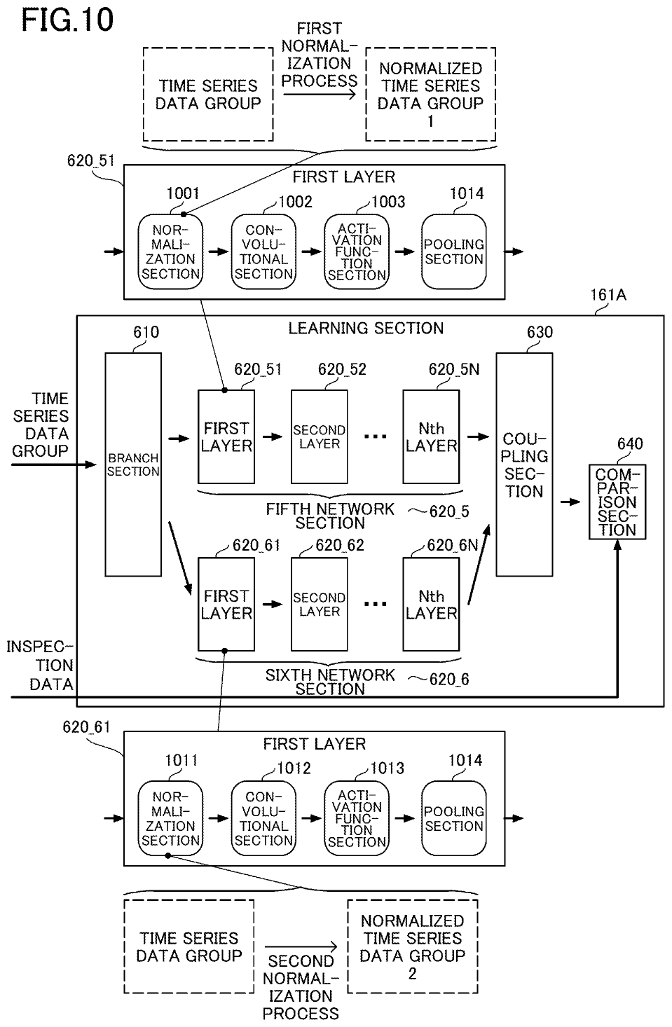

FIG. 10 is a diagram illustrating a specific example of processing of a normalization section included in each network section. As illustrated in FIG. 10, each layer of the fifth network section 620_5 includes a normalization section, a convolutional section, an activation function section, and a pooling section.

The example of FIG. 10 illustrates that, of each layer included in the fifth network section 620_5, a first layer 620_51 includes a normalization section 1001, a convolutional section 1002, an activation function section 1003, and a pooling section 1004.

Of these, the normalization section 1001 performs a first normalization process on the time series data group input by the branch section 610 and generates a normalized time series data group 1 (first time series data group).

Similarly, the example of FIG. 10 illustrates that, of each layer included in the sixth network section 620_6, a first layer 620_61 includes a normalization section 1011, a convolutional section 1012, an activation function section 1013, and a pooling section 1014.

Of these, the normalization section 1011 performs a second normalization process on the time series data group input by the branch section 610 and generates a second normalized time series data group 2 (second time series data group).

As described above, by performing machine learning with a configuration of processing a time series data group using a plurality of network sections each of which includes a normalization section that performs a normalization process using a different method, the time series data group can be analyzed in a multifaceted manner. As a result, it is possible to generate a virtual measurement model (inference section 162A) that realizes high-precision inference compared to a case in which a time series data group is input to one network section that performs one normalization process and machine learning is performed.

(4) Detail 4 of Processing of Branch Section

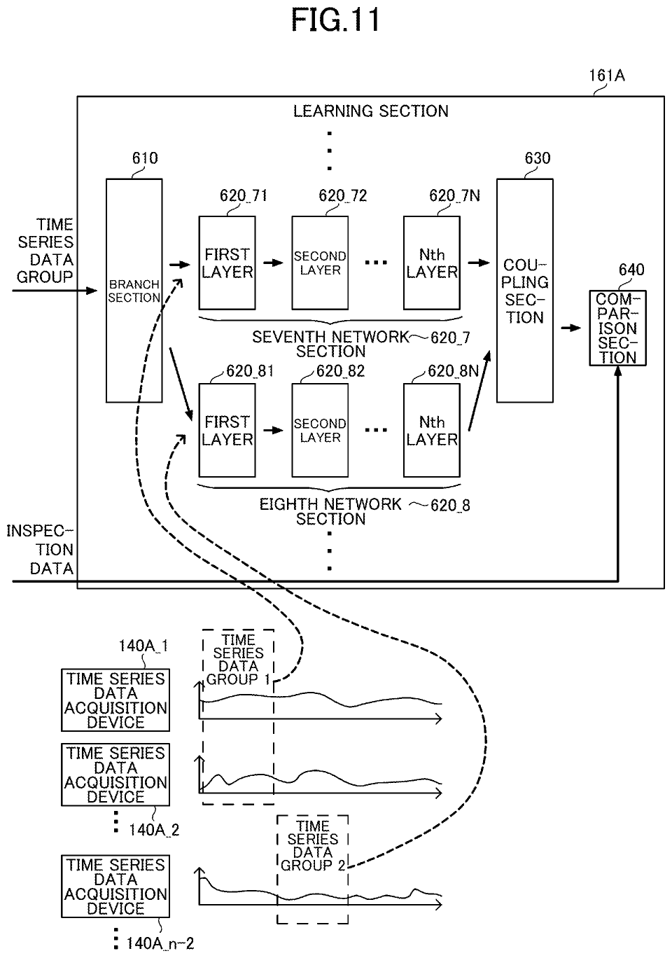

Next, another processing of the branch section 610 will be described in detail. FIG. 11 is a fourth diagram illustrating a specific example of processing of the branch section. In a case of FIG. 11, the branch section 610 inputs the time series data group 1 (the first time series data group) measured in accordance with the processing in the chamber A to the seventh network section 620_7 among the time series data groups measured by the time series data acquisition devices 140A_1 to 140A_n.

The branch section 610 inputs the time series data group 2 (the second time series data group) measured in accordance with the processing in the chamber B to the eighth network section 620_8 among the time series data groups measured by the time series data acquisition devices 140A_1 to 140A_n.

As described above, by performing machine learning with a configuration of using different network sections to process respective time series data groups measured in accordance with the processing in the different chambers (the first processing space and the second processing space), the time series data groups space) can be analyzed in a multifaceted manner. As a result, it is possible to generate a virtual measurement model (inference section 162A) that realizes high-precision inference compared to a case in which machine learning is performed by inputting respective time series data groups to one network section.

<Function Configuration of Inference Section of Virtual Measurement Device>

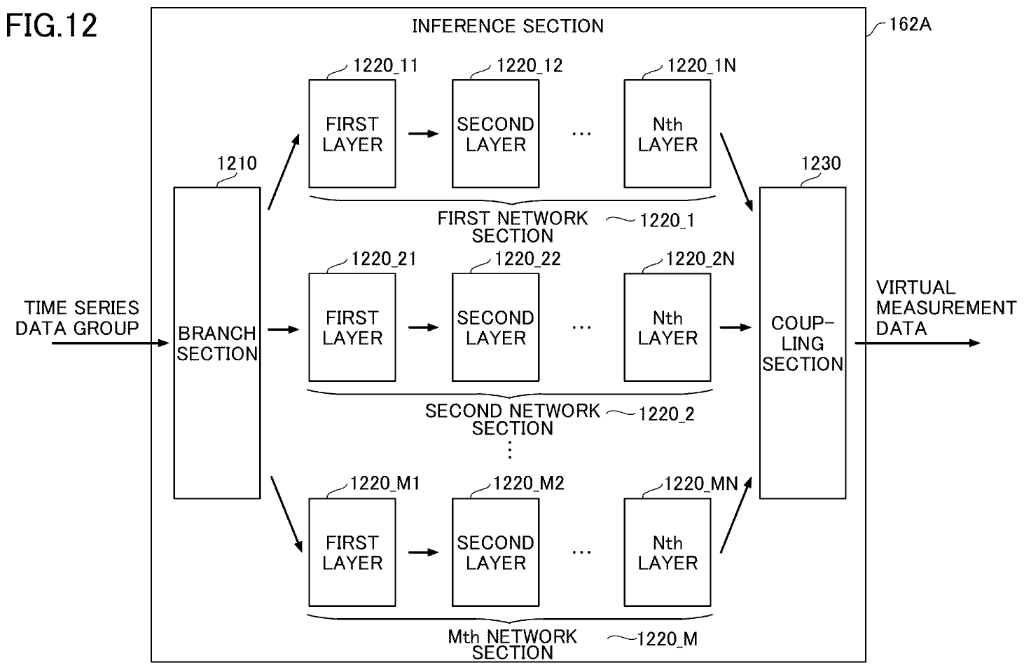

Next, a functional configuration of the inference section 162A of the virtual measurement device 160A in the system 100A will be described. FIG. 12 is a diagram illustrating an example of the functional configuration of the inference section of the virtual measurement device. As illustrated in FIG. 12, the inference section 162A of the virtual measurement device 160A includes a branch section 1210, a first network section 1220_1 to a Mth network section 1220_M, and a coupling section 1230.

The branch section 1210 acquires a time series data group newly measured by the time series data acquisition devices 140A_1 to 140A_N. The branch section 1210 performs control so that the acquired time series data group is processed using the first network section 1220_1 to the Mth network section 1220_M.

The first network section 1220_1 to the Mth network section 1220_M are formed by machine learning performed by the learning section 161A and optimizing model parameters of respective layers of the first network section 20_1 to the Mth network section 620_M.

The coupling section 1230 is formed by the coupling section 630 for which machine learning is performed by the learning section 161A and model parameters are optimized. The coupling section 1230 combines the respective output data from the output data output from the Nth layer 1220_1N of the first network section 1220_1 to the output data output from the Nth layer 1220_MN of the Mth network section 1220_M and outputs the virtual measurement data.

<Flow of Virtual Measurement Processing>

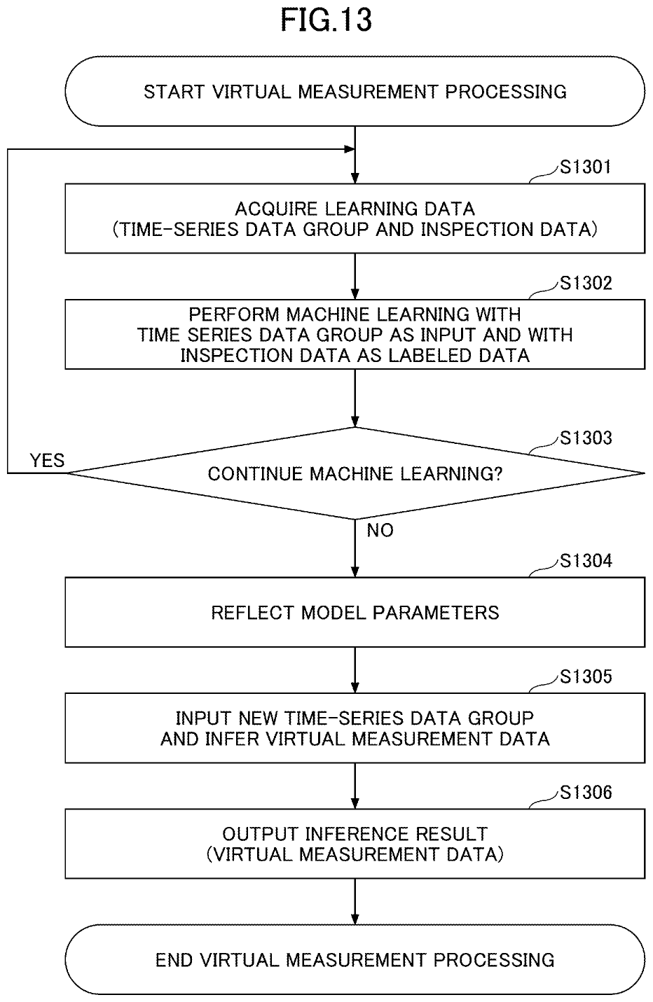

Next, the entire flow of virtual measurement processing by the virtual measurement device 160A in the system 100A will be described. FIG. 13 is a flowchart illustrating a flow of virtual measurement processing performed by the virtual measurement device.

In step S1301, the learning section 161A acquires a time series data group and inspection data as learning data.

In step S1302, the learning section 161A performs machine learning with the time series data group as input data and the inspection data as labeled data of the acquired learning data.

In step S1303, the learning section 161A determines whether or not to continue machine learning. In a case of acquiring further learning data to continue the machine learning (in the case of YES in step S1303), the processing returns to step S1301. Meanwhile, in a case of ending the machine learning (in the case of NO in step S1303), the processing proceeds to step S1304.

In step S1304, the inference section 162A generates the first network section 1220_1 to the Mth network section 1220_M by reflecting the model parameters optimized by the machine learning.

In step S1305, the inference section 162A inputs a time series data group measured in accordance with the processing of a new wafer 110A before processing and infers virtual measurement data.

In step S1306, the inference section 162A outputs the inferred virtual measurement data.

<Functional Configuration of Inference Section with Fine-Tuning Function of Virtual Measurement Device>

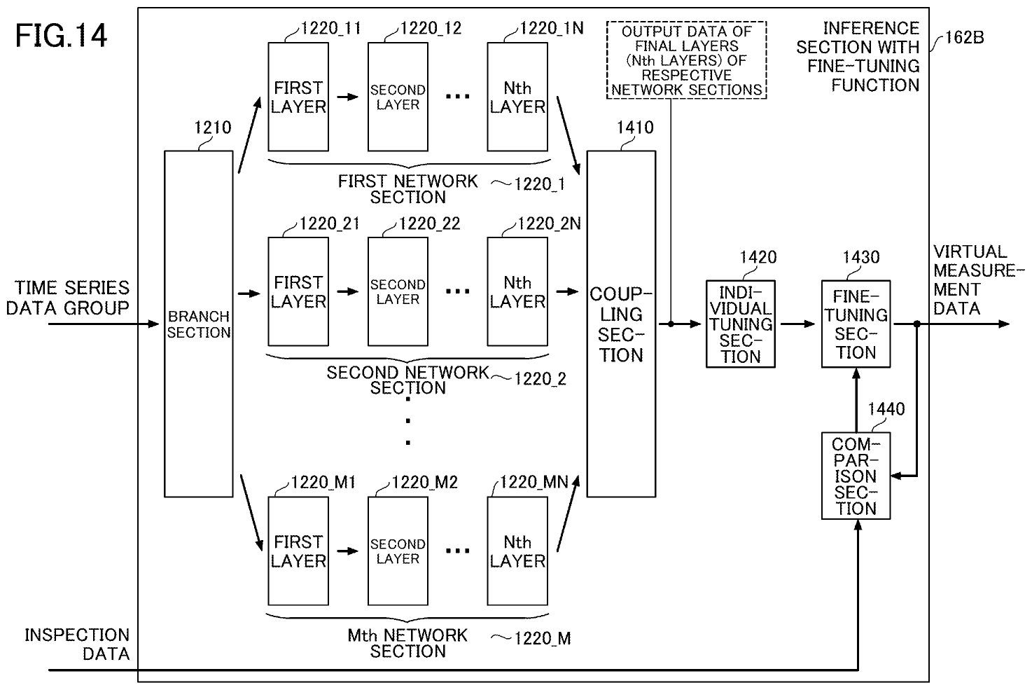

Next, a functional configuration of the inference section 162B with a fine-tuning function of the virtual measurement device 160B in the system 100B will be described. FIG. 14 is a diagram illustrating an example of the functional configuration of the inference section with a fine-tuning function of the virtual measurement device.

As illustrated in FIG. 14, the inference section 162B with a fine-tuning function of the virtual measurement device 160B includes a branch section 1210 that functions as an acquisition section. Further, the inference section 162B with a fine-tuning function of the virtual measurement device 160B includes a first network section 1220_1 to a Mth network section 1220_M, a coupling section 1410, an individual tuning section 1420, a fine-tuning section 1430, and a comparison section 1440, which function as an inference section.

Of these, since the branch section 1210 is the same as the branch section 1210 of the inference section 162A and has been described with reference to FIG. 12, the description thereof will be omitted here. The first network section 1220_1 to the Mth network section 1220_M are the same as the first network section 1220_1 to the Mth network section 1220_M of the inference section 162A.

Specifically, the first network section 1220_1 to the Mth network section 1220_M are formed by machine learning performed by the learning section 161A and optimizing model parameters of respective layers of the first network section 20_1 to the Mth network section 620_M.

The coupling section 1410 is formed by the coupling section 630 for which machine learning is performed by the learning section 161A and model parameters are optimized. However, in a case of the coupling section 1410, the respective output data from the output data output from the Nth layer 1220_1N of the first network section 1220_1 to the output data output from the Nth layer 1220_MN of the Mth network section 1220_M are output without being combined.

The individual tuning section 1420 multiplies the respective output data output from the coupling section 1410 by a factor (referred to as the “individual sensitivity”) corresponding to the individual difference between the processing unit 120A of the semiconductor manufacturing process A and the processing unit 120B of the semiconductor manufacturing process B.

The fine-tuning section 1430 multiplies the respective output data, by which the individual sensitivity is multiplied by the individual tuning section 1420, a correction matrix to calculate virtual measurement data that is the scalar quantity.

The comparison section 1440 acquires the virtual measurement data output by the fine-tuning section 1430 and acquires inspection data for the wafer 130B after processing. The comparison section 1440 calculates the difference between the acquired virtual measurement data and the inspection data and sends a notification to the fine-tuning section 1430.

Thus, in the inference section 162B with a fine-tuning function, the fine-tuning section 1430 updates the correction parameters (P₁ to P_{M}) based on the inspection data for the wafer 130B after processing for a predetermined period of time in the semiconductor manufacturing process B. The fine-tuning section 430 of the inference section 162B with the fine-tuning function continues to update the correction parameters (P₁ to P_{M}) until the difference between the virtual measurement data and the inspection data is equal to or less than a predetermined threshold value.

This enables the fine-tuning section 1430 to reduce errors (errors included in the inference result) caused by the individual difference between the processing unit 120A of the semiconductor manufacturing process A and the processing unit 120B of the semiconductor manufacturing process B.

In a case of the inference section 162B with a fine-tuning function, the cost and time can be reduced compared to a case where, with time series data group measured in the semiconductor manufacturing process B as added data and a virtual measurement model is optimized by re-learning.

<Flow of Fine-Tuning Processing>

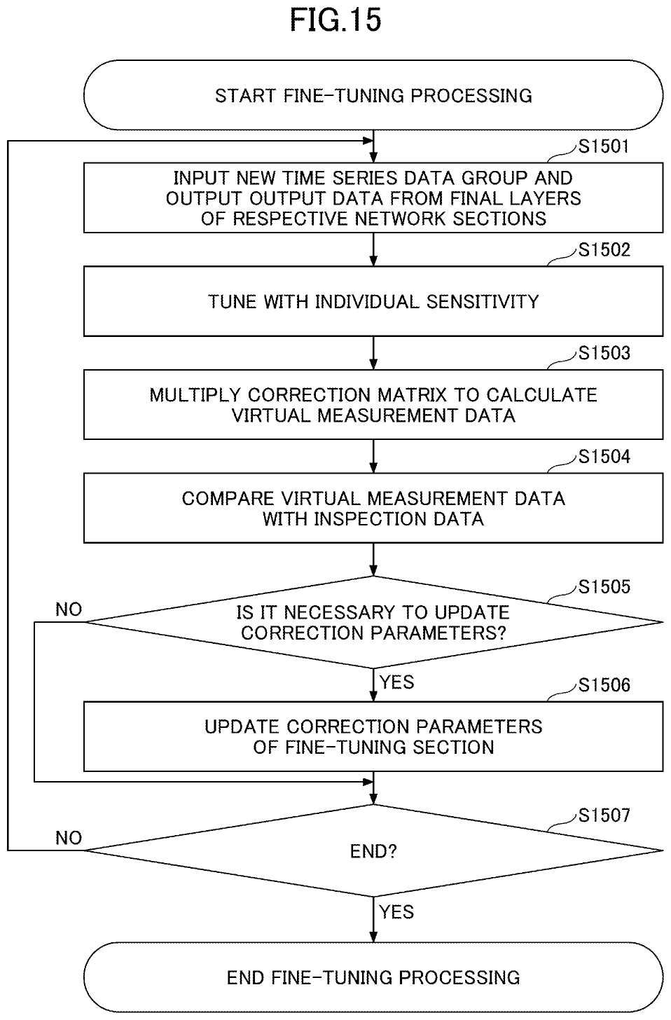

Next, a flow of fine-tuning processing performed by the virtual measurement device 160B in the system 100B will be described. FIG. 15 is a flowchart illustrating a flow of fine-tuning processing by the virtual measurement device.

In step S1501, the branch section 1210 of the inference section 162B with a fine-tuning function acquires a time series data group measured in accordance with the processing of a new wafer 110B before processing in the processing unit 120B of the semiconductor manufacturing process B. The first to Mth network sections 1220_1 to 1220_M of the inference sections 162B with a fine-tuning function process the acquired time series data group. Accordingly, the respective output data are output from the final layers of the first to Mth network sections 1220_1 to 1220_M.

In step S1502, the individual tuning section 1420 of the inference section 162B with a fine-tuning function tunes the respective output data by multiplying the respective output data output from the final layers of the first to Mth network sections 1220_1 to 1220_M by the individual sensitivity.

In step S1503, the fine-tuning section 1430 of the inference section 162B with a fine-tuning function multiplies the respective output data, by which the individual sensitivity is multiplied, by the correction matrix to calculate the virtual measurement data.

In step S1504, the inference section 162B with a fine-tuning function acquires inspection data for the post-processed wafer 130B and sends a notification to the comparison section 1440. Also, the comparison section 1440 compares the virtual measurement data output from the fine-tuning unit 1430 with the reported inspection data and calculates the difference (error included in the inference result).

In step S1505, the comparison section 1440 of the inference section 162B with a fine-tuning function determines whether or not it is necessary to update the correction parameters by determining whether or not the difference is equal to or less than the predetermined threshold value based on the comparison result.

In a case of determining in step S1505 that the difference exceeds the predetermined threshold value and it is necessary to update the correction parameters (in the case of YES in step S1505), the processing proceeds to step S1506.

In step S1506, the fine-tuning section 1430 of the inference section 162B with a fine-tuning function updates correction parameters (P₁ to P_{M}) of the correction matrix in accordance with the difference (error included in the inference result) calculated by the comparison section 1440. Thereafter, the processing proceeds to step S1507.

Meanwhile, in a case of determining in step S1505 that the difference is equal to or less than the predetermined threshold value and it is not necessary to update the correction parameters (in the case of NO in Step S1505), the processing proceeds directly to step S1507.

In step S1507, the inference section 162B with a fine-tuning function determines whether to end the fine-tuning processing. In a case of determining in step S1507 not to end the fine-tuning processing (in the case of NO in step S1507), the processing returns to step S1501.

Meanwhile, in a case of determining in step S1507 to end the fine-tuning processing (in the case of YES in step S1507), the fine-tuning processing ends.

<Summary>

As is obvious from the above description, the virtual measurement device 160A

acquires a time series data group measured in accordance with the processing of a target in a predetermined processing unit of a manufacturing process; and

performs machine learning for respective network sections so that the combined result of respective output data output from the respective network sections by processing the acquired time series data group using the plurality of network sections approaches inspection data of a result object obtained by processing the target object.

As described above, multifaceted analysis can be performed by processing a time series data group using a plurality of network sections. As a result, the virtual measurement device 160A can generate a virtual measurement model that realizes high-precision inference.

Also, the virtual measurement device 160B (inference device)

uses a plurality of network sections included in the generated virtual measurement model to process a time series data group measured in accordance with the processing of a target in a predetermined processing unit of another manufacturing process to output respective output data;

combines the respective output data after being fine-tuned using correction parameters to infer virtual measurement data; and

updates the correction parameters according to an error included in the inferred virtual measurement data.

As described above, when applying a virtual measurement model generated using a time series data group to another manufacturing process at a predetermined processing unit of a manufacturing process, the virtual measurement device 160B adds a function to fine-tune respective output data that is output from a plurality of network sections.

This enables to reduce errors (errors included in an inference result) due to individual differences between processes when applying the virtual measurement model to other manufacturing processes. That is, according to the first embodiment, an inference device, an inference method, and an inference program that can realize high-precision inference regardless of an application target can be provided.

### Second Embodiment

In the above-described first embodiment, respective output data output from the final layers of the respective network sections are fine-tuned using an individual sensitivity and a correction matrix. However, the method of fine-tuning the respective output data by the inference section with a fine-tuning function is not limited thereto. For example, a network section for fine-tuning may be used to fine-tune the respective output data.

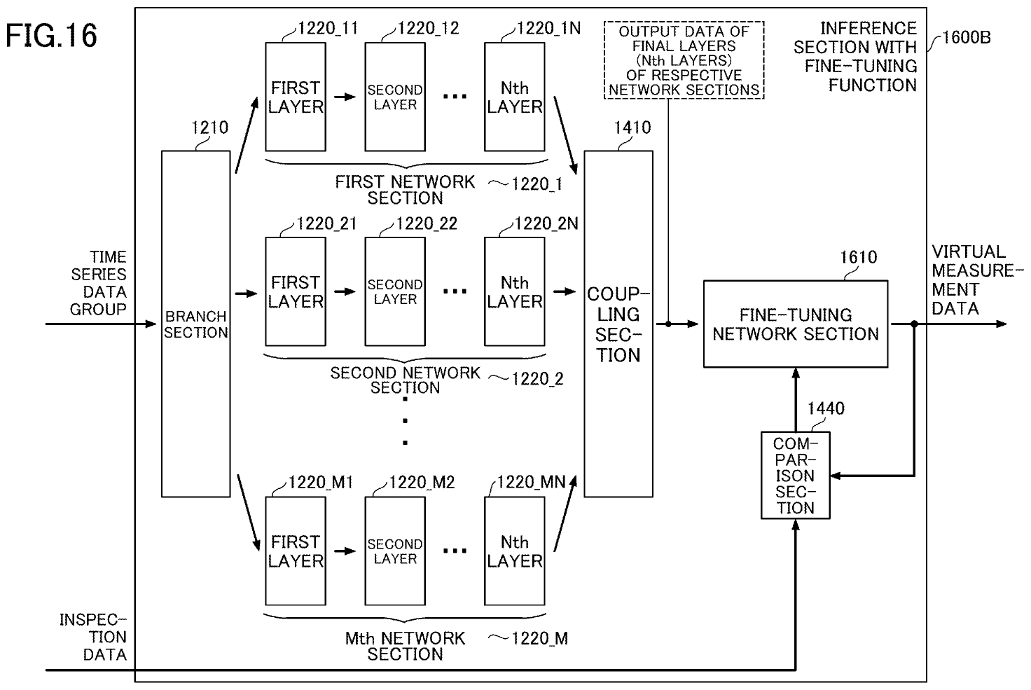

FIG. 16 is a second diagram illustrating an example of a functional configuration of an inference section with a fine-tuning function of the virtual measurement device. For the difference from FIG. 14, in a case of the inference section 1600B with a fine-tuning function illustrated in FIG. 16, a fine-tuning network section 1610 is included.

The fine-tuning network section 1610 is configured based on a convolutional neural network and outputs virtual measurement data by inputting respective output data output from the coupling section 1410.

The fine-tuning network section 1610 updates the correction parameters that are model parameters of the fine-tuning network section 1610 based on the difference reported from the comparison section 1440 in accordance with the output of the virtual measurement data.

Thus, in the inference section 1600B with a fine-tuning function, the fine-tuning network section 1610 updates the correction parameters based on the inspection data for the wafer 130B after processing for a predetermined period of time in the semiconductor manufacturing process B. At this time, the model parameters of the first network section 1220_1 to the Mth network section 1220_M are be maintained in a fixed state. Then, the fine-tuning network section 16100 of the inference section 1600B with a fine-tuning function continues to update the correction parameters until the difference between the virtual measurement data and the inspection data is equal to or less than a predetermined threshold value.

This enables the fine-tuning network section 1610 to reduce an error (an error included in an inference result) caused by an individual difference between the processing unit 120A of the semiconductor manufacturing process A and the processing unit 120B of the semiconductor manufacturing process B.

In a case of the inference section 1600B with a fine-tuning function, the possibility of overfitting can be reduced compared to a case in which a virtual measurement model is newly generated and it is optimized using a time series data group measured in the semiconductor manufacturing process B.

### Third Embodiment

In the first and second embodiments described above, a virtual measurement model generated by the virtual measurement device 160A is applied to another semiconductor manufacturing process B. However, the model applied to another semiconductor manufacturing process B is not limited to the virtual measurement model.

In a third embodiment, a case is described in which the virtual measurement devices 160A and 160B described in the first and second embodiments are read as the abnormality detection devices 160A and 160B and an abnormality detection model generated by the abnormality detection device 160A is applied to another semiconductor manufacturing process B.

In a case of the abnormality detection device 160A, the learning section 161A performs machine learning on an abnormality detection model (inference section 162A) with a time series data group as input data and an event (information indicating the presence or absence of an abnormality) as labeled data. The abnormality detection model (inference section 162A) has a similar configuration to the virtual measurement model (inference section 162A), and differs only in learning data used for machine learning.

In a case of the abnormality detection device 160A, examples of the time series data acquisition devices 140A_1 to 140A_n that output a time series data group used for machine learning include:

an emission spectroscopy analyzer that outputs OES (Optical Emission Spectrometry) data, which is a time series data group;

a process data acquisition device that outputs process data such as temperature data or pressure data, which is a time series data group; and

a radio-frequency power supply device for plasma that outputs RF data, which is time series data.

Also, in a case of the abnormality detection device 160B (inference device), the inference section 1600B with a fine-tuning function inputs the time series data group and infers information indicating the presence or absence of an abnormality.

In a case of the abnormality detection device 160B, examples of the time series data acquisition devices 140A_1 to 140A_n that output a time series data group used for inference include:

an emission spectroscopy analyzer that outputs OES (Optical Emission Spectrometry) data, which is a time series data group;

a process data acquisition device that outputs process data such as temperature data or pressure data, which is a time series data group; and

a radio-frequency power supply device for plasma that outputs RF data, which is time series data.

<Summary>

As is obvious from the above description, the abnormality detection device 160A

acquires a time series data group (OES data, process data, RF data) measured in accordance with the processing of a target in a predetermined processing unit of a manufacturing process; and

performs machine learning for respective network sections so that the combined result of respective output data output from the respective network sections by processing the acquired time series data group using the plurality of network sections approaches an invent (information indicating the presence or absence of an abnormality) that occurs in accordance with the processing of the target.

In this way, by processing a time series data group using a plurality of network sections, it is possible to perform multifaceted analysis. As a result, the abnormality detection device 160A can generate an abnormality detection model that realizes high-precision inference.

Also, the abnormality detection device 160B (inference device)

uses a plurality of network sections included in the generated abnormality detection model to process a time series data group (OES data, process data, RF data) measured in accordance with the processing of a target object in a predetermined processing unit of another manufacturing process to output respective output data;

combines the respective output data after being fine-tuned using correction parameters to infer information indicating the presence or absence of an abnormality; and

updates the correction parameters according to an error included in the inferred information indicating the presence or absence of an abnormality.

As described above, when applying an anomality detection model generated using a time series data group to another manufacturing process at a predetermined processing unit of a manufacturing process, the anomality detection device 160B adds a function to fine-tune respective output data that is output from a plurality of network sections.

This enables to reduce errors (errors included in an inference result) due to individual differences between processes when applying the virtual measurement model to other manufacturing processes. That is, according to the third embodiment, an inference device, an inference method, and an inference program that can realize high-precision inference regardless of an application target can be provided.

### Other Embodiments

In the above-described first and second embodiments, a case is described in which an individual sensitivity and a correction matrix or a network section for fine-tuning are used as a method of fine-tuning each output data. However, the method of fine-tuning respective output data is not limited thereto, and, for example, a generalized linear mixed model, Gaussian process regression analysis, Kalman filter, or the like may be used.

In the third embodiment described above, the abnormality detection device acquires OES data, process data, or RF data output from an emission spectroscopic analyzer, a process data acquisition device, or a radio-frequency power supply device for plasma in accordance with the processing of a target object. However, the combination of data acquired by the abnormality detection device is not limited thereto. Any one of data may be acquired, or a combination of two data may be acquired.

In each of the above-described embodiments, the inference sections 162B and 1600B with a fine-tuning function include the first to Mth network sections 1220_1 to 1220_M. However, the inference sections 162B and 1600B with a fine-tuning function are not required to include all of first to Mth network sections 1220_1 to 1220_M, but include at least two or more of the network sections.

In each of the above-described embodiments, a machine learning algorithm of each network section of the learning section 161A is described as being configured based on a convolutional neural network. However, the machine learning algorithm of each network section of the learning section 161A is not limited to a convolutional neural network, and may be configured based on other machine learning algorithms.

In each of the embodiments described above, the virtual measurement device or the abnormality detection device 160A functions as the learning section 161A and the inference section 162A. However, a device functioning as the learning section 161A need not be integral with a device functioning as the inference section 162A, but may be configured separately. That is, the virtual measurement device or the abnormality detection device 160A may function as the learning section 161A not including the inference section 162A, or may function as the inference section 162A not including the learning section 161A.

In each of the embodiments described above, a virtual measurement device (or an abnormality detection device) in which a fine-tuning function is added to a virtual measurement model (or an abnormality detection model) generated in the system 100A is to applied to the system 100B. However, the application target to which the virtual measurement device (or the abnormal detection device), to which a fine-tuning function is added, is applied is not limited to other systems, but may be the own system.

For example, in a case where the degree of change is small, such as a case where a part of a process recipe is changed, a fine-tuning function may be added to a virtual measurement model (or an abnormal detection model) generated by the own system.

Alternatively, it may be applied when the accuracy of a virtual measurement model (or an abnormality detection model) generated by the own system decreases, for example, when a maintenance work such as parts replacement is performed on a device in the own system, or when the environment inside a device changes due to consumption of parts of the device in the own system.

The present invention is not limited to configurations illustrated here, such as combinations with other elements in the configurations and the like described in the above embodiments. These respects can be changed without departing from the spirit of the present invention, and can be determined appropriately in accordance with the application form.

The present application is based on and claims priority to Japanese Patent Application No. 2019-217439, filed on Nov. 29, 2019, the entire contents of the Japanese Patent Application are hereby incorporated herein by reference.

### DESCRIPTION OF THE REFERENCE NUMERALS

100A, 100B: System
110A, 110B: Wafer before processing
120A, 120B: Processing Unit
130A, 130B: Wafer after processing
140A_1 to 140A_n: Time series data acquisition device
140B_1 to 140B_n: Time series data acquisition device
150A, 150B: Inspection data acquisition device
160A, 160B: Virtual measurement device
161A: Learning section
162A: Inference section
162B: Inference section with fine-tuning function
200: Semiconductor manufacturing device
610: Branch section
620_1: First network section
620_11 to 620_1N: First Layer to Nth Layer
620_2: Second network section
620_21 to 620_2N: First Layer to Nth Layer
620_M: Mth network section
620_M1 to 620_MN: First Layer to Nth Layer
630: Coupling section
640: Comparison section
1001, 1011: Normalization section
1004, 1014: Pooling section
1210: Branch section
1220_1: First network section
1220_11 to 1220_1N: First layer to Nth layer
1220 2: Second network section
1220_21 to 1220_2N: First layer to Nth layer
1220_M: Mth Network section
1220_M1 to 1220_MN: First layer to Nth layer
1240: Coupling section
1410: Coupling section
1420: Individual tuning section
1430: Fine-tuning section
1440: Comparison section
1600B: Inference section with fine-tuning function
1610: Fine-tuning network section

1. An inference device comprising:
a memory; and
a processor that is coupled to the memory and that is configured to;
acquire a time series data group measured in accordance with processing of a target object in a predetermined processing unit of a manufacturing process;
function as a machine-learned version of a plurality of network sections and a machine-learned version of a coupling section, the plurality of network sections being configured to process the acquired time series data group to output respective output data, the coupling section being configured to combine the respective output data to output a combined result, and the plurality of network sections and the coupling section being machine-learned such that the combined result output from the coupling section approaches inspection data that is obtained from a resultant object obtained by processing the target object; and
tune the respective output data that is output by processing the acquired time series data group using the machine-learned version of the plurality of network sections and that is not combined by the machine-learned version of the coupling section, and output an inference result by combining the respective tuned output data;
wherein the processor is configured to tune the respective output data using a correction parameter corresponding to an error included in the inference result.

2. The inference device according to claim 1, wherein the processor is configured to update the correction parameter so as to reduce the error included in the inference result in a state in which model parameters of the machine-learned version of the plurality of network sections is fixed.

3. The inference device according to claim 2,
wherein the processor is configured to generate a first time series data group and a second time series data group by processing the acquired time series data group according to a first criterion and a second criterion, respectively, and to process the generated first time series data group and the second time series data group using the machine-learned version of the plurality of networks sections.

4. The inference device according to claim 2,
wherein the processor is configured to divide the acquired time series data group into groups according to a data type or a time range and to process the respective divided groups using the machine-learned version of the plurality of network sections.

5. The inference device according to claim 2, wherein the processor is configured to process the acquired time series data group using the machine-learned version of the plurality of network sections, each of which includes a normalization section that performs a normalization process using a different method.

6. The inference device according to claim 2, wherein the processor is configured to:
divide the acquired time series data group into
a first time series data group that is measured in accordance with the processing of the target object in a first processing space of the predetermined processing unit, and
a second time series data group that is measured in accordance with the processing of the target object in a second processing space; and
process the first time series data group and the second time series data group using the machine-learned version of the plurality of network sections.

7. The inference device according to claim 1, wherein the time series data group is data measured in accordance with processing in a substrate processing device.

8. An inference method comprising:
acquiring a time series data group measured in accordance with processing of a target object in a predetermined processing unit of a manufacturing process;
processing the acquired time series data group by using a machine-learned version of a plurality of network sections and a machine-learned version of a coupling section, the plurality of network sections being configured to process the acquired time series data group too output respective output data, the coupling section being configured to combine the respective output data to output a combined result, and the plurality of network sections and the coupling section being machine-learned such that the combined result output from the coupling section approaches inspection data that is obtained from a resultant object obtained by processing the target object; and
tuning the respective output data that is output by processing the acquired time series data group using the machine-learned version of the plurality of network sections and that is not combined by the machine-learned version of the coupling section, and outputting an inference result by combining the respective tuned output data;
wherein the respective output data are tuned using a correction parameter corresponding to an error included in the inference result.

9. A non-transitory recording computer readable medium storing an inference program that causes a computer to execute:
acquiring a time series data group measured in accordance with processing of a target object in a predetermined processing unit of a manufacturing process;
processing the acquired time series data group by using a machine-learned version of a plurality of network sections and a machine-learned version of a coupling section, the plurality of network sections being configured to process the acquired time series data group to output respective output data, the coupling section being configured to combine the respective output data to output a combined result, and the plurality of network sections and the coupling section being machine-learned such that the combined result output from the coupling section approaches inspection data that is obtained from a resultant object obtained by processing the target object; and
tuning the respective output data that is output by processing the acquired time series data group using the machine-learned version of the plurality of network sections and that is not combined by the machine-learned version of the coupling section, and outputting an inference result by combining the respective tuned output data;
wherein the respective output data are tuned using a correction parameter corresponding to an error included in the inference result.
